(19) United States
(12) Patent Application Publication
(10) Pub. No.: US 2026/0226291 A1
(43) Pub. Date: Aug. 6, 2026

(54) FIRE-RETARDANT POWDER COATINGS

(71) Applicant: PPG Industries Ohio, Inc., Cleveland, OH (US)

(72) Inventors: Manuel Rudi Hermann Schmid, Korntal-Münchingen (DE); Shuang Ma, Nieuw-Vennep (NL)

(73) Assignee: PPG Industries Ohio, Inc., Cleveland, OH (US)

(21) Appl. No.: 19/154,053

(22) PCT Filed: Feb. 13, 2024
(86) PCT No.: PCT/US2024/015641

§ 371 Date: Aug. 6, 2025

Related U.S. Application Data
(60) Provisional application No. 63/484,735, filed on Feb. 13, 2023.

(51) Int. Cl. C09D 5/18; C08G 59/40; C08K 3/22; C08K 3/26; C08K 3/32; C08K 3/34; C08K 3/36; C08K 5/54; C08K 7/00; C09D 5/03; C09D 5/44; C09D 7/40; C09D 7/61; C09D 7/63; C09D 163/00; H01M 50/24

(52) U.S. Cl. CPC C09D 5/18; C08G 59/4021; C09D 5/035; C09D 5/44; C09D 7/61; C09D 7/63; C09D 7/70; C09D 163/00; H01M 50/24; C08K 2003/2227; C08K 2003/2241; C08K 2003/265; C08K 2003/323; C08K 3/346; C08K 3/36; C08K 5/54; C08K 7/00; C08K 2201/003

(57) ABSTRACT

The present disclosure is directed to a fire-retardant powder coating composition comprising a) a film-forming component; b) a phosphate source; and c) a filler material comprising clay, calcium carbonate, aluminum hydroxide, or clay and silica. Also disclosed are substrates coated with the powder coating composition, and methods of coating substrates.

### FIELD

The present disclosure is directed to a fire-retardant powder coating composition, a method for coating a substrate with said composition, a substrate coated with said composition, and an article comprising said substrate, including energy storage devices.

### BACKGROUND

Fire-retardant coatings have been used for a variety of structural applications to protect against both cellulosic and hydrocarbon fires. Such coatings offer protection by offering flame resistance to the coated substrate. Numerous substrates may benefit from being coated with such coatings, including structural building components used, for example, in commercial and transportation infrastructures like hotels, airports, concert halls, offshore sites, chemical plants, oil rigs, and the like, that would be exposed to extreme heat in the case of fire. Energy storage devices, such as batteries, including lithium-ion batteries, may also be exposed to such intense heat. Many such devices are vulnerable to thermal runaways during which heat and gas are rapidly discharged and a fire hazard is created. Improved fire-retardant coatings, including those used for energy storage devices, are therefore desired.

### SUMMARY

The present disclosure is directed to a fire-retardant powder coating composition comprising a) a film-forming component; b) a phosphate source; and c) a filler material comprising clay and optionally silica, wherein the clay and optional silica combined is present in an amount of greater than 5% by weight, based on the total weight of the composition.

The present disclosure is directed to a fire-retardant powder coating composition comprising a) a film-forming component; b) a phosphate source; and c) a filler material comprising calcium carbonate, wherein calcium carbonate is present in an amount of greater than 10% by weight when the composition comprises titanium dioxide in an amount of at least 5% by weight, based on the total weight of the composition.

The present disclosure is directed to a fire-retardant powder coating composition comprising a) a film-forming component; b) a phosphate source; and c) a filler material comprising aluminum hydroxide, wherein aluminum hydroxide is present in an amount of greater than 10% by weight when the composition comprises titanium dioxide in an amount of at least 5% by weight, based on the total weight of the composition; and wherein the composition further comprises less than 5% by weight of an organo silane.

Also disclosed herein is a substrate coated with a powder coating composition comprising a) a film-forming component; b) a phosphate source; and c) a filler material comprising clay and optionally silica, wherein the clay and optional silica combined is present in an amount of greater than 5% by weight, based on the total weight of the composition.

Also disclosed herein is a substrate coated with a powder coating composition comprising a) a film-forming component; b) a phosphate source; and c) a filler material comprising calcium carbonate, wherein calcium carbonate is present in an amount of greater than 10% by weight, based on the total weight of the composition, when the composition comprises titanium dioxide in an amount of at least 5% by weight, based on the total weight of the composition.

Also disclosed herein is a substrate coated with a powder coating composition comprising a) a film-forming component; b) a phosphate source; and c) a filler material comprising aluminum hydroxide, wherein aluminum hydroxide is present in an amount of greater than 10% by weight, based on the total weight of the composition, when the composition comprises titanium dioxide in an amount of at least 5% by weight, based on the total weight of the composition, and wherein the composition further comprises less than 5% by weight of an organo silane.

Further disclosed herein is a method of coating a substrate comprising optionally electrodepositing a coating from an electrodepositable coating composition to at least a portion of a surface of the substrate to form an electrodeposited coating layer; and applying the fire-retardant powder coating composition over at least a portion of the surface of the substrate or the electrodeposited coating layer, if present, by electrostatic spraying or fluidized bed application to form a fire-retardant powder coating layer.

### DETAILED DESCRIPTION

The present disclosure is directed to a powder coating composition comprising: a) a film-forming component; b) a phosphate source; and c) a filler.

A coating composition refers to a solution, a mixture, a powder, or a dispersion, that, in an at least partially dried or cured state, is capable of producing a film layer, or the like, on at least a portion of a substrate surface. As used herein, a powder coating composition refers to any coating composition in the form of a co-reactable solid in particulate form that is substantially or completely free of water and/or solvent.

The present coating composition may be used to form fire-retardant coatings. “Flame-retardant” as used herein means a coating that minimizes the likelihood of a fire. A “fire-retardant” coating according to the present disclosure is one that, when applied to one side of a steel panel that is 0.8 to 1.2 mm thick and cured to a dry film thickness of 600 microns+/−100 microns, and the uncoated side of the substrate is exposed to a torch fire at 1450±50° C. at a thermal output of >5 kW, will not catch fire after five minutes of exposure to the flame and, further, will not catch fire after exposure to such thermal output for five minutes when the char directly above the flame impacted area is cut to expose the substrate (and still subjected to the flame). This test is intended to mimic a thermal runaway event in a battery and is referred to herein as the “Thermal Runaway Test.”

The fire-retardant powder coating composition comprises a film-forming component. As used herein, the term “film-forming component”, which may be used interchangeably with “binder”, refers to a constituent, film-forming material that holds all coating composition components together in a coating layer upon cure. The binder comprises one or more film-forming resins that may be used to form the coating layer. The binder may optionally further comprise one or more crosslinkers. The one or more crosslinkers may be selected from any of the crosslinkers known in the art to react with the one or more pendant and/or terminal functional groups of the one or more film-forming resins used in the powder coating composition. “Film-forming” means that the composition, upon drying and/or curing, may form a continuous film on a surface. Any film-forming resin may be used according to the present disclosure. As used herein, the term “film-forming resin” may be used interchangeably with “polymer” or “resin”, and refers to one or more polymers, such as homopolymers and/or copolymers, as well as prepolymers, oligomers, and monomers, that are capable of forming a film upon reaction with a curing agent or crosslinker, or by drying or self-crosslinking. As used herein, the term “crosslinker”, “curing agent”, and like terms, refer to a molecule capable of forming a covalent linkage between polymers or between two different regions of the same polymer.

The film-forming component of the powder coating composition may be thermosetting or thermoplastic. Thermosetting or thermoset coating compositions may cure or crosslink under ambient conditions or with exposure to heat or other energy sources. Curing refers to bond formation, such as between a polymer and crosslinker, or self-crosslinking, resulting in the formation of a crosslinked coating film. Ambient conditions refer to temperatures that are typically found in the room or area in which a coating composition is being applied to a substrate, for example, from 10° C. to 40° C., while thermal or bake conditions (“heat”) are temperatures that are above ambient temperature. Thermoplastic coating compositions may coalesce to form a film upon exposure to an energy source, such as heat.

Non-limiting examples of suitable film-forming resins that may form at least a portion of the binder of the powder coating composition include (meth)acrylate resins, polyurethanes, polyesters, polyamides, polyethers, polysiloxanes, epoxy resins, vinyl resins, copolymers thereof, and combinations thereof. As used herein, “(meth)acrylate” and like terms refer both to the acrylate and the corresponding methacrylate. Further, the film-forming resins may have any of a variety of functional groups including, but not limited to, carboxylic acid groups, amine groups, epoxide groups, hydroxyl groups, thiol groups, carbamate groups, amide groups, urea groups, isocyanate groups (including blocked isocyanate groups), ethylenically unsaturated groups, and combinations thereof. As used herein, “ethylenically unsaturated” refers to a group having at least one carbon-carbon double bond. Non-limiting examples of ethylenically unsaturated groups include, but are not limited to, (meth)acrylate groups, vinyl groups, and combinations thereof.

Thermosetting coating compositions typically comprise a crosslinker that may be selected from any of the crosslinkers known in the art to react with the functionality of one or more film-forming resins used in the powder coating composition.

Non-limiting examples of crosslinkers include phenolic resins, amino resins, epoxy resins, triglycidyl isocyanurate, guanadines, dicyandiamide, tertiary amines, imidazoles, mercaptans, aromatic, alicyclic, and/or aliphatic anhydrides, beta-hydroxy (alkyl) amides, alkylated carbamates, (meth)acrylates, salts of poly carboxylic acids with cyclic amidine, o-tolyl biguanide, isocyanates, blocked isocyanates, polyacids, anhydrides, organometallic acid-functional materials, polyamines, polyamides, aminoplasts, carbodiimides, oxazolines, and/or derivatives and combinations thereof.

As mentioned above, the binder of the powder coating composition may comprise one or more film-forming resins and optionally one or more crosslinkers. A binder that comprises two or more different film-forming resins may be referred to as a hybrid binder. The hybrid binder may further comprise one or more crosslinkers comprising functionality that is reactive with functionality on one or more of the film forming resins in the hybrid binder; a functionality that is produced by the reaction of the different functional groups on the separate resins in the hybrid binder may further react with functional resins in the hybrid binder and/or with functional groups on a curing agent. In a non-limiting example, a binder comprising one or more epoxy resins, and one or more polyester and/or one or more acrylic resins, wherein the polyester and/or acrylic resins comprise polycarboxylic acid functionality that may react with an epoxy, the reaction product may comprise hydroxyl functionality and the curing agent may comprise an isocyanate or blocked isocyanate that may react with the hydroxyl functionality of the reaction product.

A non-limiting example of a hybrid binder is provided in Int'l Pub. No. WO 2018/187755 A1, at par. [0015] to [0033], the cited portion of which is incorporated herein by reference.

Alternatively, the binder of the powder coating composition may comprise a single film-forming resin, such as any of the film-forming resins disclosed herein, for example, an epoxy resin.

In other cases, the binder of the powder coating composition may comprise two or more film-forming resins having the same reactive functionality. In a nonlimiting example, the film-forming resin may comprise two or more epoxy functional film-forming resins.

The one or more film-forming resins, in any combination such as a single resin, two or more film forming resins of the same functionality, or as in a hybrid binder, may be present in the binder in an amount of at least 10% by weight, such as at least 20% by weight, at least 30% by weight, or at least 40% by weight, based on the total weight of the binder. The film-forming resin may be present in the binder in an amount of up to 99.9% by weight, such as up to 80% by weight, such as up to 60% by weight, such as up to 50% by weight, based on the total weight of the binder. The film-forming resin may be present in the binder an amount from 10% to 99.9% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder.

As previously described, the powder coating composition of the present disclosure may comprise an epoxy resin. Non-limiting examples of suitable epoxy functional polymers include, but are not limited to, diglycidyl ethers of bisphenol A, polyglycidyl ethers of polyhydric alcohols, polyglycidyl esters of polycarboxylic acids, and combinations thereof. Non-limiting examples of suitable epoxy resins are also commercially available from Nan Ya Plastics under the trade name NPES-903, and from Hexion under the trade names EPON™ 2002 and EPON 2004™.

The epoxy functional polymer may have an equivalent weight of at least 200 or at least 500 or at least 675. The epoxy functional polymer may also comprise an equivalent weight of up to 5100 or up to 1000. The epoxy functional polymer may comprise an equivalent weight within the range of 200 to 5100 or from 200 to 1000 or from 500 to 5100 or from 500 to 1000 or from 675 to 5100 or from 675 to 1000. As used herein, “equivalent weight” refers to the average weight molecular weight of a resin given in g/mol divided by the number of functional groups per molecule. As such, the equivalent weight of the epoxy functional polymer is determined by dividing the average weight molecular weight of the epoxy resin by the total number of epoxide groups and any other optional functional groups that are not an epoxide. Further, the average weight molecular weight is determined by gel permeation chromatography relative to linear polystyrene standards of 800 to 900,000 Daltons as measured with a Waters 2695 separation module with a Waters 410 differential refractometer (RI detector). Tetrahydrofuran (THF) is used as the eluent at a flow rate of 1 ml min-1, and two PLgel Mixed-C (300×7.5 mm) columns are used for separation.

It is appreciated that the epoxy functional polymer may comprise one or multiple types of epoxy functional polymers. When multiple epoxy functional polymers are used, the multiple epoxy functional polymers may have the same or different equivalent weights. For instance, a first epoxy functional polymer may have an equivalent weight that is greater than an equivalent weight of a second epoxy functional polymer. The epoxy functional polymers may also include additional functional groups besides the epoxy functional groups including, but not limited to, any of the previously described functional groups. Alternatively, the epoxy functional polymer may be free of any one, or all, of the previously described functional groups besides the epoxy functional groups.

The powder coating composition may comprise, for example, a polyester, such as a hydroxyl functional polyester. The powder composition may comprise a hybrid resin comprising a polycarboxylic acid functional polyester and/or a polycarboxylic acid functional acrylic resin, and an epoxy resin. In all cases, the polyester may comprise any suitable polyester as known to those skilled in the art and the acrylic resin may comprise any suitable acrylic resin as known to those skilled in the art.

Any of the binders described herein, comprising one or more resins, may further comprise a crosslinker. The crosslinker may be present in the binder an amount of at least 0.1% by weight, such as at least 1% by weight, such as at least 3% by weight, such as at least 10% by weight, such as at least 20% by weight, based on the total weight of the binder. The crosslinker may be present in the binder an amount of up to 70 weight %, such as up to 50 weight %, such as up to 35 weight %, such as up to 20% by weight, based on the total weight of the binder. The crosslinker may be present in the binder an amount of from 0.1% to 70% by weight, such as 0.1% to 50% by weight, such as 0.1% to 35% by weight, such as 0.1% to 20% by weight, such as 1% to 70% by weight, such as 1% to 50% by weight, such as 1% to 35% by weight, such as 1% to 20% by weight, such as 3% to 70% by weight, such as 3% to 50% by weight, such as 3% to 35% by weight, such as 3% to 20% by weight, such as 10% to 70% by weight, such as 10% to 50% by weight, such as 10% to 35% by weight, such as 10% to 20% by weight, based on the total weight of the binder.

As described, the binder may optionally comprise a crosslinker such as, but not limited to, any of those recited herein. For example, when the binder comprises an epoxy resin, suitable crosslinkers include any of those as known in the art, such as, dicyanamide, polyamines, polyamides, imidazoles, mercaptans, aromatic, alicyclic, and/or aliphatic anhydrides, guanadines, derivatives, and combinations thereof.

A non-limiting example of a binder of the powder coating composition is a binder comprising, consisting essentially of, or consisting of (a) a film-forming resin, such as an epoxy resin; and (b) a crosslinker. The film-forming resin, such as an epoxy resin, may be present in an amount of at least 10% by weight, such as at least 20% by weight, at least 30% by weight, or at least 40% by weight, based on the total weight of the binder. The film-forming resin, such as an epoxy resin, may be present in the binder in an amount of up to 97% by weight, such as up to 80% by weight, such as up to 60% by weight, such as up to 50% by weight, based on the total weight of the binder. The film-forming resin, such as an epoxy resin, may be present in the binder an amount from 10% to 97% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder.

The crosslinker, such as but not limited to dicyanamide, containing functional groups that are reactive with the epoxy resin, may be present in the binder an amount of at least 0.1% by weight, such as at least 1% by weight, such as at least 3% by weight, such as at least 10% by weight, such as at least 20% by weight, based on the total weight of the binder. The crosslinker may be present in the binder an amount of up to 70 weight %, such as up to 50 weight %, such as up to 35 weight %, such as up to 20% by weight, based on the total weight of the binder. The crosslinker may be present in the binder an amount of from 0.1% to 70% by weight, such as 0.1% to 50% by weight, such as 0.1% to 35% by weight, such as 0.1% to 20% by weight, such as 1% to 70% by weight, such as 1% to 50% by weight, such as 1% to 35% by weight, such as 1% to 20% by weight, such as 3% to 70% by weight, such as 3% to 50% by weight, such as 3% to 35% by weight, such as 3% to 20% by weight, such as 10% to 70% by weight, such as 10% to 50% by weight, such as 10% to 35% by weight, such as 10% to 20% by weight, based on the total weight of the binder.

The crosslinker, such as dicyandiamide, may comprise any stoichiometric mixing ratio with the functional groups on a resin, such as an epoxy resin, within the weight ratio parameters as described above. The stoichiometric mixing ratio of a curing agent with a film-forming resin having functional groups, such as epoxy groups, may be calculated by dividing the equivalent weight of the curing agent by the equivalent weight of the resin. For example, the equivalent weight of the curing agent may be calculated by dividing the molecular weight of the curing agent by the number of its functional groups. In a nonlimiting example, the amine H equivalent weight of dicyanamide may be calculated by dividing its molecular weight, 84 g/mole, by 4, that is the number of active H, which yields an equivalent weight of 21. The equivalent weight of a resin, such as an epoxy, may be provided by the supplier, and/or determined by analytical techniques as known to those skilled in the art or described herein. The coating composition may comprise any stoichiometric mixing ratio of equivalence of functional groups of the curing agent to the equivalence of functional groups, such as epoxy, of the film-forming resin, within the weight ratio parameters as described above. The crosslinker may be used in stoichiometric mixing ratio of 0.1:1 to 10:1, such as 0.2:1 to 6.5:1, such as 0.4:1 to 3:1, such as 0.5:1 to 1.5:1, such as 0.65:1 to 1.3:1.

The crosslinker, such as dicyanamide commercially available from AlzChem, may be used in any mixing ratio of moles of crosslinker ratio to equivalents of epoxy within the weight ratio parameters as described above.

The powder coating composition may comprise a resin, such as a polyester, comprising functionality, such as hydroxyl functional groups, or a hybrid resin, comprising a hydroxyl functional group derived as described above, and a crosslinker, such as an isocyanate that is reactive with hydroxy functional groups.

The isocyanate functional crosslinker may include various types of polyisocyanates. Polyisocyanates that may be used include aliphatic and aromatic diisocyanates as well as higher functional polyisocyanates. Non-limiting examples of suitable polyisocyanates include isophorone diisocyanate (IPDI), dicyclohexylmethane 4,4′-diisocyanate (H12MDI), cyclohexyl diisocyanate (CFIDI), m-tetramethylxylylene diisocyanate (m-TMXDI), p-tetramethylxylylene diisocyanate (p-TMXDI), ethylene diisocyanate, 1,2-diisocyanatopropane, 1,3-diisocyanatopropane, 1,6-diisocyanatohexane (hexamethylene diisocyanate or HDI), 1,4-butylene diisocyanate, lysine diisocyanate, 1,4-methylene bis-(cyclohexyl isocyanate), toluene diisocyanate (TDI), m-xylylenediisocyanate (MXDI) and p-xylylenediisocyanate, 4-chloro-1,3-phenylene diisocyanate, 1,5-tetrahydro-naphthalene diisocyanate, 4,4′-dibenzyl diisocyanate, and 1,2,4-benzene triisocyanate, xylylene diisocyanate (XDI), and mixtures or combinations thereof.

The isocyanate crosslinker may comprise a blocked isocyanate functional crosslinker. A “blocked isocyanate” refers to a compound with isocyanate functional groups that have been reacted with a blocking agent that prevents the isocyanate functionality from reacting until the blocking agent is removed upon exposure to an external stimulus such as heat. Non-limiting examples of blocking agents include phenols, pyridinols, thiophenols, methylethylketoxime, amides, caprolactam, imidazoles, and pyrazoles. The isocyanate may also include a uretdione isocyanate such as a uretdione internally blocked isocyanate adduct.

A binder of the powder coating composition is a binder comprising, consisting essentially of, or consisting of (a) an epoxy resin; and (b) a crosslinker comprising dicyanamide. The epoxy resin may be present in an amount of at least 10% by weight, such as at least 20% by weight, at least 30% by weight, or at least 40% by weight, based on the total weight of the binder. The epoxy resin may be present in the binder in an amount of up to 97% by weight, such as up to 80% by weight, such as up to 60% by weight, such as up to 50% by weight, based on the total weight of the binder. The epoxy resin may be present in the binder an amount from 10% to 97% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder. The crosslinker, comprising dicyanamide, may be present in the binder an amount of at least 0.1% by weight, such as at least 1% by weight, such as at least 3% by weight, such as at least 10% by weight, such as at least 20% by weight, based on the total weight of the binder. The crosslinker, comprising dicyanamide, may be present in the binder an amount of up to 70 weight %, such as up to 50 weight %, such as up to 35 weight %, such as up to 20% by weight, based on the total weight of the binder. The crosslinker, comprising dicyanamide, may be present in the binder an amount of from 0.1% to 70% by weight, such as 0.1% to 50% by weight, such as 0.1% to 35% by weight, such as 0.1% to 20% by weight, such as 1% to 70% by weight, such as 1% to 50% by weight, such as 1% to 35% by weight, such as 1% to 20% by weight, such as 3% to 70% by weight, such as 3% to 50% by weight, such as 3% to 35% by weight, such as 3% to 20% by weight, such as 10% to 70% by weight, such as 10% to 50% by weight, such as 10% to 35% by weight, such as 10% to 20% by weight, based on the total weight of the binder.

The film forming component may be present in an amount of at least 40% by weight, such as at least 45% by weight, such as at least 50% by weight, such as at least 55% by weight, such as at least 60% by weight, such as at least 70% by weight, such as at least 75% by weight, based on the total weight of the composition. The film-forming component may be present in an amount of no more than 79.9% by weight, such as no more than 70% by weight, such as no more than 60% by weight, based on the total weight of the composition. The film-forming component may be present in an amount of 40% to 79.9% by weight, such as 40% to 70% by weight, such as 40% to 60% by weight, such as 45% to 79.9% by weight, such as 45% to 70% by weight, such as 45% to 60% by weight, such as 50% to 79.9% by weight, such as 50% to 70% by weight, such as 50% to 60% by weight, such as 55% to 79.9% by weight, such as 55% to 70% by weight, such as 55% to 60% by weight, such as 60% to 79.9% by weight, such as 60% to 70% by weight, such as 70% to 79.9% by weight, based on the total weight of the composition.

The thermosetting binder may be present in an amount of greater than 40% by weight, such as at least 45% by weight, such as at least 50% by weight, such as at least 55% by weight, such as at least 60% by weight, such as at least 70% by weight, such as at least 75% by weight, based on the total weight of the composition. The thermosetting binder may be present in an amount of no more than 79.9% by weight, such as no more than 70% by weight, such as no more than 60% by weight, based on the total weight of the composition. The thermosetting binder may be present in an amount of greater than 40% by weight to no more than 79.9% by weight, such as greater than 40% by weight to no more than 70% by weight, such as greater than 40% by weight to no more than 60% by weight, such as 45% to 79.9% by weight, such as 45% to 70% by weight, such as 45% to 60% by weight, such as 50% to 79.9% by weight, such as 50% to 70% by weight, such as 50% to 60% by weight, such as 55% to 79.9% by weight, such as 55% to 70% by weight, such as 55% to 60% by weight, such as 60% to 79.9% by weight, such as 60% to 70% by weight, such as 70% to 79.9% by weight, based on the total weight of the composition.

The thermoplastic binder may be present in an amount of greater than 40% by weight, such as at least 50% by weight, such as at least 60% by weight, such as at least 70% by weight, such as at least 75% by weight, based on the total weight of the composition. The thermoplastic binder may be present in an amount of no more than 79.9% by weight, such as no more than 70% by weight, such as no more than 60% by weight, based on the total weight of the composition. The thermoplastic binder may be present in an amount of greater than 40% by weight to no more than 79.9% by weight, such as greater than 40% by weight to no more than 70% by weight, such as greater than 40% by weight to no more than 60% by weight, such as such as 50% to 79.9% by weight, such as 50% to 70% by weight, such as 50% to 60% by weight, such as 60% to 79.9% by weight, such as 60% to 70% by weight, such as 70% to 79.9% by weight, based on the total weight of the composition.

The powder coating composition of the present disclosure further comprises a phosphate source. The phosphate source serves as a fire-retardant. A phosphate source as used herein means any phosphorus-containing material that comprises phosphoric acid or condensation or dehydration products (including oxides) thereof, or salts, esters, amides or other derivatives of any of the foregoing. The phosphate source may comprise a variety of materials, such as, for example, phosphoric acid, mono- and diammonium phosphate, triphenyl phosphate, tris-(2-chloroethyl)phosphate, tri(2-chloroisopropyl)phosphate, phosphorus-containing amides such as phosphorylamide, and melamine pyrophosphate. For example, the source of phosphorous may be an ammonium polyphosphate represented by the formula (NH₄)ₙ₊₂PₙO₃ₙ₊₁, wherein n is an integer of at least 2, or n is an integer of at least 50. The composition of the present disclosure may contain the phosphate source in an amount of at least 15% by weight, such as at least 18% by weight, such as at least 20% by weight, such as at least 25% by weight, such as at least 30% by weight, such as at least 35% by weight, such as at least 40% by weight, based on the total weight of the composition. The coating composition may comprise the phosphate source in an amount of no more than 50% by weight, such as no more than 45% by weight, such as no more than 40% by weight, such as no more than 35% by weight, such as no more than 30% by weight, such as no more than 25% by weight, based on the total weight of the composition. The coating composition may comprise the phosphate source in an amount in a range between any of the above-mentioned values such as from 15% to 50% by weight, such as 15% to 45% by weight, such as 15% to 40% by weight, such as 15% to 35% by weight, such as 15% to 30% by weight, such as 15% to 25% by weight, such as 18% to 50% by weight, such as 18% to 45% by weight, such as 18% to 40% by weight, such as 18% to 35% by weight, such as 18% to 30% by weight, such as 18% to 25% by weight, such as 20% to 50% by weight, such as 20% to 45% by weight, such as 20% to 40% by weight, such as 20% to 35% by weight, such as 20% to 30% by weight, such as 20% to 25% by weight, such as 25% to 50% by weight, such as 25% to 45% by weight, such as 25% to 40% by weight, such as 25% to 35% by weight, such as 25% to 30% by weight, such as 25% to 25% by weight based on the total weight of the composition.

The powder coating composition of the present disclosure further comprises a filler comprising clay, calcium carbonate, aluminum hydroxide, or clay and silica.

As used herein, the term “clay” refers to hydrous aluminum phyllosilicates such as kaolin clay (also referred to as kaolinite), smectite clay, or bentonite clay.

The clay filler may have a lamellar structure. Particles having a lamellar structure are composed of sheets or plates of atoms in hexagonal array, with strong bonding within the sheet and weak van der Waals bonding between sheets, providing low shear strength between sheets.

The silica may comprise any types of silica such as crystalline or non-crystalline silica, amorphous, fused, precipitated, natural or synthetic, such as those manufactured in a sol-gel process.

The silica and clay may be a commercially manufactured mixture or composite, or a natural mixture or a composite, such as a natural combination of corpuscular Neuburg silica and kaolinite. A non-limiting example of a natural combination of corpuscular Neuburg silica and kaolinite may have the chemical formula SiO₂+Al₂[(OH)₄Si₂O₅].

The filler may comprise additional organic or inorganic material and may comprise particles of a single type of filler material or may comprise particles of two or more types of filler materials. That is, the filler material may comprise particles of a first filler material and may further comprise particles of at least a second (i.e., a second, a third, a fourth, etc.) filler material that is different from the first filler material. As used herein with respect to types of filler material, reference to “first,” “second”, etc. is for convenience only and does not refer to order of addition or the like.

Other fillers may optionally be further included and selected from among a large array of conventionally utilized materials, including synthetic and natural materials, such as but not limited to talc, mica, diatomaceous earth, wollastonite, LAPINUS, glass, ceramics, metal oxides, hollow spheres, barium sulfate, magnesium silicate, borosilicate, calcium silicate, zinc oxide, aluminum oxide, aluminum silicate, magnesium aluminum silicate, gypsum, feldspar, synthetic inorganic and organic fillers and the like. The filler may comprise composite materials or composite particles such as synthetic or natural materials comprising two or more materials, such as in a non-limiting example, a silica and a clay. Other fillers include dolomite; zinc borate; magnesium carbonate; calcium oxide; calcium silicate; sodium aluminum silicate; calcium metasilicate; titanium dioxide and/or barium sulphate.

The fillers may be added to the composition individually, may be mixed during manufacture, and/or may be naturally occurring mixtures of materials. Alternatively, the fillers may be mixed prior to adding to the component to make the composition of the present disclosure.

The filler may comprise one or more materials in any ratio. For example, the filler may comprise two materials, three materials or four or more materials. The ratio of the first filler to the second filler in a filler comprising two materials may be 1:99 to 99:1, such as 1:9 to 9:1, such as 1:7 to 7:1, such as 1:5 to 5:1, such as 1:3 to 3:1, such as 1:2 to 2:1, such as 1:1 to 1:3, such as 1:2 to 1:3.

The first filler may be a clay, such as kaolin clay, and the second filler may be silica.

The fillers may be treated, such as, but not limited to calcined, or surface treated, such as, but not limited to treatment with a silane or a wax.

The filler material may have any particle shape or geometry. For example, the filler material may be a regular or irregular shape and may be spherical, ellipsoidal, cubical, platy, acicular (elongated or fibrous), rod-shaped, disk-shaped, prism-shaped, flake-shaped, rock-like, etc., agglomerates thereof, and any combination thereof. Some natural fillers, for example, may comprise a silica having a rounded grain shape.

Particles of filler material may have an average particle size in at least one dimension of at least 0.01 microns, as reported by the manufacturer, such as at least 0.1 microns, such as at least 2 microns, such as at least 10 microns. Particles of filler material may have a reported average particle size in at least one dimension of no more than 500 microns as reported by the manufacturer, such as no more than 300 microns, such as no more than 200 microns, such as no more than 150 microns. The particles of filler material may have a reported average particle size in at least one dimension of 0.01 microns to 500 microns as reported by the manufacturer, such as 0.1 microns to 300 microns, such as 2 microns to 200 microns, such as 10 microns to 150 microns. Suitable methods of measuring average particle size include measurement using an instrument such as the Quanta 250 FEG SEM or an equivalent instrument.

The filler may comprise particles comprising aggregates or agglomerates of primary particles. The primary particles may have an average primary particle size, such as 50 nm or greater, such as 100 nm or greater, such as 200 nm or greater. The filler may comprise a rounded grain shape silica and comprise aggregated primary particles of 200 nm diameter.

The filler may be present in the composition in an amount greater than 5% by weight, such as at least 10% by weight, such as greater than 10% by weight, such as at least 15% by weight, such as at least 20% by weight, based on the total weight of the composition. The filler may be present in the composition in an amount no more than 70% by weight, such as no more than 50% by weight, such as no more than 40% by weight, such as no more than 30% by weight, such as no more than 25% by weight, such as no more than 20% by weight, such as no more than 15% by weight, based on the total weight of the composition. The filler may be present in the composition in an amount of greater than 5% to no more than 70% by weight, such as greater than 5% to 50% weight, such as greater than 5% to 40% by weight, such as greater than 5% to 30% by weight, such as greater than 5% to 25% by wight, such as greater than 5% to 20% by weight, such as greater than 5% to 15% by weight, such as 10% to 70% by weight, such as 10% to 50% by weight, such as 10% to 40% by weight, such as 10% to 30% by weight, such as 10% to 25% by weight, such as 10% to 20% by weight, such as 10% to 15% by weight, such as greater than 10% to 70% by weight, such as greater than 10% to 50% by weight, such as greater than 10% to 40% by weight, such as greater than 10% to 30% by weight, such as greater than 10% to 25% by weight, such as greater than 10% to 20% by weight, such as greater than 10% to 15% by weight, such as 15% to 70% by weight, such as 15% to 50% by weight, such as 15% to 40% by weight, such as 15% to 30% by weight, such as 15% to 25% by weight, such as 20% to 70% by weight, such as 20% to 50% by weight, such as 20% to 40% by weight, such as 20% to 30% by weight, such as 20% to 25% by weight, based on the total weight of the composition.

Clay may be present in the composition in an amount of greater than 5% by weight, such as at least 10% by weight, such as at least 15% by weight, such as at least 20% by weight, based on the total weight of the composition. Clay may be present in the composition in an amount no more than 70% by weight, such as no more than 50% by weight, such as no more than 40% by weight, such as no more than 30% by weight, such as no more than 25% by weight, such as no more than 20% by weight, such as no more than 15% by weight, based on the total weight of the composition. Clay may be present in the composition in an of greater than 5% to no more than 70% by weight, such as greater than 5% to 50% weight, such as greater than 5% to 40% by weight, such as greater than 5% to 30% by weight, such as greater than 5% to 25% by wight, such as greater than 5% to 20% by weight, such as greater than 5% to 15% by weight, such as 10% to 70% by weight, such as 10% to 50% by weight, such as 10% to 40% by weight, such as 10% to 30% by weight, such as 10% to 25% by weight, such as 10% to 20% by weight, such as 10% to 15% by weight, such as greater than 10% to 70% by weight, such as greater than 10% to 50% by weight, such as greater than 10% to 40% by weight, such as greater than 10% to 30% by weight, such as greater than 10% to 25% by weight, such as greater than 10% to 20% by weight, such as greater than 10% to 15% by weight, such as 15% to 70% by weight, such as 15% to 50% by weight, such as 15% to 40% by weight, such as 15% to 30% by weight, such as 15% to 25% by weight, such as 20% to 70% by weight, such as 20% to 50% by weight, such as 20% to 40% by weight, such as 20% to 30% by weight, such as 20% to 25% by weight, based on the total weight of the composition.

The clay and optional silica may be present in the composition in a combined amount of greater than 5% by weight, such as at least 10% by weight, such as at least 15% by weight, such as at least 20% by weight, based on the total weight of the composition. The clay and optional silica may be present in the composition in a combined amount no more than 70% by weight, such as no more than 50% by weight, such as no more than 40% by weight, such as no more than 30% by weight, such as no more than 25% by weight, such as no more than 20% by weight, such as no more than 15% by weight, based on the total weight of the composition. The clay and optional silica may be present in the composition in a combined amount of greater than 5% to 70% by weight, such as greater than 5% to 50% weight, such as greater than 5% to 40% by weight, such as greater than 5% to 30% by weight, such as greater than 5% to 25% by wight, such as greater than 5% to 20% by weight, such as greater than 5% to 15% by weight, such as 10% to 70% by weight, such as 10% to 50% by weight, such as 10% to 40% by weight, such as 10% to 30% by weight, such as 10% to 25% by weight, such as 10% to 20% by weight, such as 10% to 15% by weight, such as greater than 10% to 70% by weight, such as greater than 10% to 50% by weight, such as greater than 10% to 40% by weight, such as greater than 10% to 30% by weight, such as greater than 10% to 25% by weight, such as greater than 10% to 20% by weight, such as greater than 10% to 15% by weight, such as 15% to 70% by weight, such as 15% to 50% by weight, such as 15% to 40% by weight, such as 15% to 30% by weight, such as 15% to 25% by weight, such as 20% to 70% by weight, such as 20% to 50% by weight, such as 20% to 40% by weight, such as 20% to 30% by weight, such as 20% to 25% by weight, based on the total weight of the composition.

Calcium carbonate may be present in the composition in an amount of greater than 5% by weight, such as at least 10% by weight, such as greater than 10% by weight, such as at least 15% by weight, such as at least 20% by weight, based on the total weight of the composition. Calcium carbonate may be present in the composition in an amount no more than 70% by weight, such as no more than 50% by weight, such as no more than 40% by weight, such as no more than 30% by weight, such as no more than 25% by weight, such as no more than 20% by weight, such as no more than 15% by weight, based on the total weight of the composition. Calcium carbonate may be present in the composition in an amount of greater than 5% to no more than 70% by weight, such as greater than 5% to 50% weight, such as greater than 5% to 40% by weight, such as greater than 5% to 30% by weight, such as greater than 5% to 25% by wight, such as greater than 5% to 20% by weight, such as greater than 5% to 15% by weight, such as 10% to 70% by weight, such as 10% to 50% by weight, such as 10% to 40% by weight, such as 10% to 30% by weight, such as 10% to 25% by weight, such as 10% to 20% by weight, such as 10% to 15% by weight, such as greater than 10% to 70% by weight, such as greater than 10% to 50% by weight, such as greater than 10% to 40% by weight, such as greater than 10% to 30% by weight, such as greater than 10% to 25% by weight, such as greater than 10% to 20% by weight, such as greater than 10% to 15% by weight, such as 15% to 70% by weight, such as 15% to 50% by weight, such as 15% to 40% by weight, such as 15% to 30% by weight, such as 15% to 25% by weight, such as 20% to 70% by weight, such as 20% to 50% by weight, such as 20% to 40% by weight, such as 20% to 30% by weight, such as 20% to 25% by weight, based on the total weight of the composition. The amount of calcium carbonate may be greater than 10% by weight when the composition comprises titanium dioxide in an amount of 5% by weight or more, based on the total weight of the composition.

Aluminum hydroxide may be present in the composition in an amount of greater than 5% by weight, such as at least 10% by weight, such as greater than 10% by weight, such as at least 15% by weight, such as at least 20% by weight, based on the total weight of the composition. Aluminum hydroxide may be present in the composition in an amount no more than 70% by weight, such as no more than 50% by weight, such as no more than 40% by weight, such as no more than 30% by weight, such as no more than 25% by weight, such as no more than 20% by weight, such as no more than 15% by weight, based on the total weight of the composition. Aluminum hydroxide may be present in the composition in an of greater than 5% to no more than 70% by weight, such as greater than 5% to 50% weight, such as greater than 5% to 40% by weight, such as greater than 5% to 30% by weight, such as greater than 5% to 25% by wight, such as greater than 5% to 20% by weight, such as greater than 5% to 15% by weight, such as 10% to 70% by weight, such as 10% to 50% by weight, such as 10% to 40% by weight, such as 10% to 30% by weight, such as 10% to 25% by weight, such as 10% to 20% by weight, such as 10% to 15% by weight, such as greater than 10% to 70% by weight, such as greater than 10% to 50% by weight, such as greater than 10% to 40% by weight, such as greater than 10% to 30% by weight, such as greater than 10% to 25% by weight, such as greater than 10% to 20% by weight, such as greater than 10% to 15% by weight, such as 15% to 70% by weight, such as 15% to 50% by weight, such as 15% to 40% by weight, such as 15% to 30% by weight, such as 15% to 25% by weight, such as 20% to 70% by weight, such as 20% to 50% by weight, such as 20% to 40% by weight, such as 20% to 30% by weight, such as 20% to 25% by weight, based on the total weight of the composition.

The powder coating compositions of the present disclosure may further include optional ingredients commonly used in such compositions. For example, the composition may further comprise cure accelerators, such as but not limited to imidazoles, tertiary amines, aromatic amine, ureas, derivatives and combinations thereof, pigments such as titanium dioxide, iron oxides, carbon black, metallic and organic pigments such as, for example, copper phthalocyanine, and the like. Non-limiting examples of additives that may be used include: colorants, anti-oxidants, hindered amine light stabilizers, UV light absorbers and stabilizers, surfactants, flow and surface control agents, thixotropic agents, reactive diluents, driers, catalysts, reaction inhibitors, adhesion promoting components, such as acids, acid derivatives, phosphatized epoxy, and silanes, such as epoxy silanes or amine silanes, and other customary additives as known to those skilled in the art. As used herein, “colorants” refers to any substance that imparts color and/or other opacity and/or other visual effect to the composition.

The powder coating composition may comprise less than 5% by weight of an organo silane, such as less than 3% by weight, such as less than 1% by weight, such as less than 0.1% by weight, based on the total weight of the powder coating composition.

The powder coating composition may comprise less than 5% by weight of titanium dioxide, such as less than 3% by weight, such as less than 1% by weight, such as less than 0.1% by weight, based on the total weight of the powder coating composition.

The powder coating composition may comprise a film-forming component comprising an epoxy resin and a curing agent, such as dicyandiamide; a phosphate source comprising ammonium polyphosphate; and a filler comprising a mixture of corpuscular silica and kaolin clay.

The powder coating composition may be prepared by mixing the previously described binder, phosphate source, filler material, and optional additional components. The components are mixed such that a homogenous mixture is formed. The components may be mixed using art-recognized techniques and equipment such as with a Prism high speed mixer for example. When a solid coating composition is formed, the homogenous mixture is next melted and further mixed. The mixture may be melted with a twin-screw extruder, single screw extruder, or a similar apparatus known in the art. During the melting process, the temperatures may be chosen to melt-mix the solid homogenous mixture without curing the mixture. The homogenous mixture may be melt-mixed in a twin-screw extruder with zones set to a temperature of 75° C. to 140° C., such as 75° C. to 125° C., such as from 85° C. to 115° C., or at 100° C.

After melt-mixing, the mixture may be cooled and re-solidified. The re-solidified mixture may then be ground such as in a milling process to form a solid particulate curable powder coating composition. The re-solidified mixture may be ground to any desired particle size. For example, in an electrostatic coating application, the re-solidified mixture may be ground to an average particle size of at least 10 microns or at least 20 microns and up to 130 microns as determined with a Beckman-Coulter LS™ 13 320 Laser Diffraction Particle Size Analyzer following the instructions described in the Beckman-Coulter LS™ 13 320 manual. Further, the particle size range of the total amount of particles in a sample used to determine the average particle size may comprise a range of from 1 micron to 200 microns, or from 5 microns to 180 microns, or from 10 microns to 150 microns, which is also determined with a Beckman-Coulter LS™ 13 320 Laser Diffraction Particle Size Analyzer following the instructions described in the Beckman-Coulter LS™ 13 320 manual.

The present disclosure is also directed to a method of coating a substrate comprising applying the powder coating composition of the present disclosure over at least a portion of a substrate. The method may further comprise at least partially curing the applied coating.

The powder coating compositions may be applied by any means standard in the art, such as spraying, electrostatic spraying, a fluidized bed process, and the like including robotic application. Application may be by precision spraying, in which the composition is sprayed to a specific portion of the substrate without overspray.

After the powder coating compositions are applied to a substrate, the compositions may be cured or at least partially cured with heat, increased or reduced pressure, chemically, such as with moisture, or with other means such as actinic radiation, and combinations thereof. The term “actinic radiation” refers to electromagnetic radiation that may initiate chemical reactions. Actinic radiation includes, but is not limited to, visible light, ultraviolet (UV) light, infrared radiation, X-ray, and gamma radiation. As used herein, the terms “curable” and the like, as used in connection with a powder coating composition, means that at least a portion of the components that make up the powder coating composition are polymerizable and/or crosslinkable including self-crosslinkable polymers.

The powder coating composition may be cured with heat, such as convection heating, within a range of from 120° C. to 260° C. for 2 to 60 minutes, or within a range of from 120° C. to 205° C. for 10 to 60 minutes, or within a range of from 148° C. to 204° C. for 10 to 60 minutes. The powder coating composition may also be cured with infrared radiation in which peak metal temperatures may reach 204° C. to 260° C. in 10 to 30 seconds. The elevated heat ramping with infrared radiation allows for fast cure times. In some examples, the powder coating composition may be cured with infrared radiation to heat the composition within a range of from 148° C. to 289° C. for 1 to 40 minutes, or within a range of from 176° C. to 275° C. for 2 to 20 minutes, or within a range of from 187° C. to 269° C. for 5 to 8 minutes.

It is appreciated that the powder coating composition may be cured with multiple types of heat sources such as both convection heating and infrared radiation. For example, the powder coating composition may be partially cured with convection heating or infrared radiation, and then completely cured with a different heat source chosen from convection heating and infrared radiation.

The powder coating compositions may also be applied in multiple applications over a substrate. For instance, a first powder coating composition may be applied over at least a portion of a substrate, and a second powder coating composition the same or different from the first may be applied over at least a portion of the first coating composition. The first powder coating composition may optionally be cured or at least partially cured before applying the second powder coating composition. Alternatively, the second powder coating composition may be applied over at least a portion of the first coating composition, and the first and second powder coating composition may then be cured together at the same time. The powder coating compositions may be cured with any of the methods previously described.

Coatings formed from a powder coating composition may be applied at any desired dry film thickness. For example, when applied as a powder, the dry film thickness may be at least 2 mils (50.8 microns), such as at least 3 mils (76.2 microns), such as at least 4 mils (101.6 microns), such as at least 5 mils (127 microns), such as at least 6 mils (152.4 microns), such as at least 8 mils (203.2 microns), such as at least 10 mils (254 microns), such as at least 12 mils (304.8 microns), such as at least 20 mils (508 microns), such as at least 40 mils (1,016 microns). For example, the dry film thickness may be less than 40 mils (1,016 microns), such as less than 20 mils (508 microns), such as less than 12 mils (304.8 microns), less than 10 mils (254 microns), less than 8 mils (203.2 microns), or less than 6 mils (152.4 microns), or less 5 mils (127 microns), or less than 4 mils (101.6 microns), or less than 3 mils (76.2 microns), or less than 2 mils (50.8 microns). The dry film thickness may be 2 to 100 mils, such as 2 to 40 mils, such as 2 to 20 mils, such as 2 to 12 mils, such as 2 to 10 mils, such as 2 to 8 mils, such as 2 to 6 mils, such as 2 to 5 mils, such as 2 to 4 mils, such as 2 to 3 mils, such as 3 to 100 mils, such as 3 to 40 mils, such as 3 to 20 mils, such as 3 to 12 mils, such as 3 to 10 mils, such as 3 to 8 mils, such as 3 to 6 mils, such as 3 to 5 mils, such as 3 to 4 mils, such as 4 to 100 mils, such as 4 to 40 mils, such as 4 to 20 mils, such as 4 to 12 mils, such as 4 to 10 mils, such as 4 to 8 mils, such as 4 to 6 mils, such as 4 to 5 mils, such as 5 to 100 mils, such as 5 to 40 mils, such as 5 to 20 mils, such as 5 to 12 mils, such as 5 to 10 mils, such as 5 to 8 mils, such as 5 to 6 mils, such as 6 to 100 mils, such as 6 to 40 mils, such as 6 to 20 mils, such as 6 to 12 mils, such as 6 to 10 mils, such as 6 to 8 mils, such as 8 to 100 mils, such as 8 to 40 mils, such as 8 to 20 mils, such as 8 to 12 mils, such as 8 to 10 mils, such as 10 to 100 mils, such as 10 to 40 mils, such as 10 to 20 mils, such as 10 to 12 mils, such as 12 to 100 mils, such as 12 to 40 mils, such as 12 to 20 mils, such as 20 to 100 mils, such as 20 to 40 mils, such as 40 to 100 mils. For example, the dry film thickness may be 100 microns. When multiple powder coating compositions are applied, each composition may be applied to separately provide any of the previously described dry film thicknesses. For instance, when two separate powder coating compositions are applied, each individual powder coating composition may be applied at any of the previously described dry film thicknesses.

Optionally, the method of coating may further comprise the application of additional coating layers under or over the powder coating composition. The additional coating layers are not limited and may comprise any suitable coating layer. For example, the coating layer of the present disclosure may comprise a first coating and one or more additional layers may be applied over at least a portion of the first coating. Alternatively, one or more additional coating layers may be applied to a substrate and the powder coating composition of the present disclosure may then be applied thereover to form the powder coating layer. The additional coating layer may comprise an electrodeposited coating layer.

The substrate may optionally comprise an electrodeposited coating layer and the powder coating layer applied thereover, such that the method may optionally comprise electrodepositing a coating from an electrodepositable coating composition to at least a portion of a surface of the substrate to form an electrodeposited coating layer.

The electrodeposited coating layer may be electrodeposited from an electrodepositable coating composition. Any electrodepositable coating composition known in the art may be used. Particularly suitable may be those containing thermally conductive, electrically insulative fillers and/or fire-retardant pigments, such as those described in Int'l Pub. No. WO 2022/133202 A1, at par. [0045] to [0089], the cited portion of which is incorporated herein by reference. Also particularly suitable may be those comprising plate-like pigments in a plate-like pigment-to-binder ratio of at least 0.4:1, such as those described in Int'l Pub. No. WO 2019/243973 A2, at, par. [0028] to [0085], Int'l Pub. No., at par. WO 2021/127327 A1, at par. [0010] to [0068], Int'l App. Ser. No. PCT/US2023/78765, at par. [0011] to [0016] and [0025] to [0205], the cited portion of which is incorporated herein by reference for each. The plate-like pigment may comprise a plate-like mica pigment, a plate-like chlorite pigment, a plate-like serpentine pigment, a plate-like talc pigment, and/or a plate-like clay pigment. The plate-like clay pigment may comprise kaolin clay. The electrodepositable coating composition, and resulting electrodeposited layer, may comprise plate-like pigment in a plate-like pigment-to-binder ratio of at least 0.4:1, such as at least 0.5:1, such as at least 0.6:1, such as at least 0.75:1, such as at least 1:1, such as at least 1.25:1, such as at least 1.5:1. The electrodepositable coating composition, and resulting electrodeposited layer, may comprise plate-like pigment in a plate-like pigment-to-binder ratio of 0.4:1 to 2:1, such as 0.4:1 to 1.75:1, such as 0.4:1 to 1.5:1, such as 0.4:1 to 1.25:1, such as 0.4:1 to 1:1, such as 0.4:1 to 0.75:1, such as 0.4:1 to 0.7:1, such as 0.4:1 to 0.6:1, such as 0.4:1 to 0.55:1, such as 0.4:1 to 0.5:1, such as 0.5:1 to 2:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.7:1, such as 0.5:1 to 0.6:1, such as 0.5:1 to 0.55:1, such as 0.6:1 to 2:1, such as 0.6:1 to 1.75:1, such as 0.6:1 to 1.5:1, such as 0.6:1 to 1.25:1, such as 0.6:1 to 1:1, such as 0.6:1 to 0.75:1, such as 0.6:1 to 0.7:1, such as 0.75:1 to 2:1, such as 0.75:1 to 1.75:1, such as 0.75:1 to 1.5:1, such as 0.75:1 to 1.25:1, such as 0.75:1 to 1:1, such as 1:1 to 2:1, such as 1:1 to 1.75:1, such as 1:1 to 1.5:1, such as 1:1 to 1.25:1, such as 1.25:1 to 2:1, such as 1.25:1 to 1.75:1, such as 1.25:1 to 1.5:1, such as 1.5:1 to 2:1, such as 1.5:1 to 1.75:1.

The present disclosure is also directed to a substrate comprising a coating layer deposited from any of the powder coating compositions described herein. The substrate may optionally comprise any of the additional coating layers discussed herein, such as an electrodeposited coating layer.

Alternatively, the compositions of the present disclosure may be formed into a self-supported film or sheet. The self-supported film or sheet may subsequently be cured to form a crosslinked self-supported film or sheet. In general, the curable compositions of the present disclosure may be formed into a film or sheet by any technique well known to a person skilled in the art, for example a cast molding process, by impregnating a mesh with the coating, and the like. The film or sheet may be cured to form a crosslinked self-supported film or sheet that may then be applied to a substrate. It is also within the present disclosure that after the forming step the uncured film or sheet is applied to a substrate and then subsequently cured to obtain the crosslinked coating layer. The film or sheet may be applied to the substrate through an adhesive. Accordingly, when reference is made herein to a substrate being “coated with”, or like terms of the present compositions, this includes coating by application of a film and/or sheet formed from the compositions(s).

The powder coating composition may be applied to any substrates known in the art, for example, automotive substrates, marine substrates, industrial substrates, heavy-duty equipment, packaging substrates, lumber, wood flooring and furniture, apparel, electronics including housings and circuit boards and including consumer electronics such as housings for computers, notebooks, smartphones, tablets, televisions, gaming equipment, computer equipment, computer accessories, MP3 players, and the like, glass and transparencies, sports equipment including golf balls, and the like. These substrates may be, for example, metallic or non-metallic. Metallic substrates include tin, steel, tin-plated steel, chromium passivated steel, galvanized steel, aluminum, and aluminum foil. Metal sheet as used herein refers to flat metal sheet and coiled metal sheet, which is coiled, uncoiled for coating and then re-coiled for shipment to a manufacturer. Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (“PET”), polycarbonate, polycarbonate acrylobutadiene styrene (“PC/ABS”), SMC, carbon fiber, polyamide, wood, veneer, wood composite, particle board, medium density fiberboard, cement, stone, glass, paper, cardboard, textiles, leather both synthetic and natural, and the like. The substrate may be part of a structure or part of a vehicle. “Structure” as used herein refers to any part of a building, bridge, transportation infrastructure, oil rig, oil platform, water tower, power line tower, support structures, wind turbines, walls, piers, docks, levees, dams, shipping containers, trailers, and any metal structure that is exposed to a corrosive environment. “Vehicle” as used herein refers to in its broadest sense all types of vehicles, such as but not limited to cars, trucks, buses, tractors, harvesters, heavy duty equipment, vans, golf carts, motorcycles, bicycles, railcars, subway cars, airplanes, helicopters, boats of all sizes and the like.

The substrate may be one that has been already treated in some manner, such as to impart visual and/or color effect. For instance, the substrate may be alkaline cleaned, deoxidized, mechanically cleaned, ultrasonically cleaned, solvent wiped, roughened, plasma cleaned or etched, exposed to chemical vapor deposition, treated with an adhesion promoter, plated, anodized, annealed, cladded, or any combination thereof prior to application of the coating composition. The substrate may be treated using any of the previously described methods prior to application of the coating composition such as by dipping the substrate in a cleaner and/or deoxidizer bath prior to applying the coating composition.

It will also be understood that the substrate may be pretreated with a pretreatment composition. As used herein, “pretreatment composition” refers to a composition that is capable of reacting with and chemically altering the substrate surface and binding to it to form a film that affords corrosion protection. The pretreatment composition may be an aqueous composition. Non-limiting examples of pretreatment compositions include a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

The substrate may also be plated prior to applying the coating composition. As used herein, “plating” refers to depositing a metal over a surface of the substrate.

The substrate may comprise a three-dimensional component formed by an additive manufacturing process such as selective laser melting, e-beam melting, directed energy deposition, binder jetting, metal extrusion, and the like. The three-dimensional component may be a metal and/or resinous component.

The present disclosure is further directed to a substrate or article coated at least in part with the powder coating composition of the present disclosure. The powder coating composition of the present disclosure may be applied to an article in any form, such as a coating composition or a crosslinked self-supported film or sheet. “Applied to” and any variants thereof when referring to the film or sheet means that the film/sheet may be affixed to an article, such as by means of an adhesive layer, or positioned within or placed within an article, such as adjacent to a fixed or movable member of the article. The article may be a structure. The article may be a vehicle. The article may be a battery component or a battery, such as a lithium-ion battery or other energy storage device. For example, the coating composition of the present disclosure or the crosslinked self-supported film or sheet may be applied to any structural element of a battery, in particular a lithium-ion battery. The battery may comprise exterior wall elements defining a housing and optionally interior wall elements, wherein the powder coating composition may be at least partially applied to the external and/or internal side of any of the exterior wall elements and/or to any side of any of the interior wall elements, if present. The exterior wall and/or interior wall elements may comprise composite, steel, aluminum, and/or polycarbonate for example. The present coating compositions may be used on the outside of a battery, or other energy storage device that is in contact with or in the proximity of other coatings, such as cataphoretic coatings, which may be flammable. This may prevent or at least minimize the likelihood of such coatings catching fire during a thermal runaway event. For example, the present composition in any form may be placed on the outside walls of a battery box, including the surface that is in contact with the body of a vehicle.

As discussed above, the substrate may comprise an energy storage device, such as a battery or battery component. The battery may be, for example, an electric vehicle battery, and the battery component may be an electric vehicle battery component. A “battery component” may be any component found in a battery, such as a lithium-ion battery. The battery component may comprise, for example, an electrode, a battery cell, a battery shell, a battery module, a battery pack, a battery box, a battery cell casing, a pack shell, a battery lid and tray, a thermal management system, a battery housing, a module housing, a module racking, a battery side plate, a battery cell enclosure, a cooling module, a cooling tube, a cooling fin, a cooling plate, a bus bar, a battery frame, an electrical connection, metal wires, copper or aluminum conductors or cables, or any part of a stationary electrical energy storage system. Other energy storage devices include, but are not limited to, fuel cells and/or hydrogen tanks.

The coating compositions according to the present disclosure may be applied to the outside surfaces of energy storage devices. For example, if applied to a battery used in an electric vehicle, the present coating compositions (or sheets/films made from the same) may contain a fire within the battery and keep the fire from spreading to other parts of the vehicle. For example, if an organic coating such as an electrocoat, primer, or other coating(s) are deposited on the battery box, the present coating compositions applied thereover may retard, if not prevent, the coating(s) from catching fire. The present coating compositions may also be used on substrates treated with an inorganic pretreatments and/or coatings. The thermal insulation of the present coating compositions may also mitigate heat damage outside of the energy storage device, such as other parts of a vehicle or structure.

It might be desirable to use one or more additional fire-retardant materials and/or fire mitigation means within and/or around the battery. For example, a thermally insulating material and/or a high strength material could be wrapped around or otherwise positioned between battery cells, or around the perimeter or interior of the battery housing. Examples of such material include fiberglass, mineral wool, silica/silica fibers, alumina, Kevlar, Nomex, calcium-silicate, or calcium silicate fibers. These materials may be, for example, in a sheet or other self-supported form. Foams could also be used, such as polyurethane/polyurea foam with fire retardants. Physical barriers may also be employed, such as cooling fins interposed between battery cells, mica boards, Aerogel blankets, and/or mineral/glass/carbon fiber-containing blankets.

To provide fire-retardant protection for articles comprising a battery and their users it is also within the present disclosure to apply the powder coating composition to a part of an article adjacent to the battery between the battery and the article. In such cases a conventional battery or a battery according to the present disclosure may be employed. The article may be, for example, a mobile phone, a tablet, or a laptop computer. Alternatively, the article may be a vehicle such as a hybrid or electric car, bus, or truck. In such vehicles it is common to position the battery, especially the lithium-ion battery due to its weight, as a flat battery pack underneath the floor portion of the vehicle body, for example the car body. In such cases, the powder coating compositions of the present disclosure may be applied to the floor portion of the vehicle adjacent to the battery between the battery and the vehicle body. In case of a thermal runaway event or a battery fire, the car body, especially the passenger cabin, would be protected by the coating layer comprising a powder coating composition of the present disclosure so that the battery box will resist flame and any fire inside the battery box will not spread into the passenger cabin and the heat-up of the passenger cabin would be limited for a prolonged period of time so that the passengers may safely escape from the vehicle.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. When ranges are given, any endpoints of those ranges and/or numbers within those ranges may be combined with the scope of the present disclosure.

As used herein, “including,” “containing” and like terms are understood in the context of this application to be synonymous with “comprising” and are therefore open-ended and do not exclude the presence of additional undescribed or unrecited elements, materials, or ingredients. Nevertheless, they also include the more restrictive terms “consisting of” and “consisting essentially of”. As used herein, “consisting of” is understood in the context of this application to exclude the presence of any unspecified element, material, or ingredient. As used herein, “consisting essentially of” is understood in the context of this application to include the specified elements, materials, or ingredients “and those that do not materially affect the basic and novel characteristic(s)” of what is being described.

In this application, the use of the singular includes the plural and plural encompasses singular, unless specifically stated otherwise. For example, although reference is made herein to “a” film-forming component, “a” film-forming resin, “a” curing agent, “a” phosphate source, “a” filler material, and the like, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

### ASPECTS

Each of the characteristics and examples described above, and combinations thereof, may be said to be encompassed by the present disclosure. The present disclosure is thus drawn in particular, without being limited thereto, to the following aspects:
Aspect 1. A fire-retardant powder coating composition comprising: a) a film-forming component; b) a phosphate source; and c) a filler material comprising clay, calcium carbonate, aluminum hydroxide, or clay and silica.
Aspect 2. The fire-retardant powder coating of aspect 1, wherein the filler comprises clay and optionally silica wherein the clay and optional silica combined is present in an amount of greater than 5% by weight, based on the total weight of the composition, such as greater than 5% to 70% by weight, such as greater than 5% to 50% weight, such as greater than 5% to 40% by weight, such as greater than 5% to 30% by weight, such as greater than 5% to 25% by wight, such as greater than 5% to 20% by weight, such as greater than 5% to 15% by weight, such as 10% to 70% by weight, such as 10% to 50% by weight, such as 10% to 40% by weight, such as 10% to 30% by weight, such as 10% to 25% by weight, such as 10% to 20% by weight, such as 10% to 15% by weight, such as greater than 10% to 70% by weight, such as greater than 10% to 50% by weight, such as greater than 10% to 40% by weight, such as greater than 10% to 30% by weight, such as greater than 10% to 25% by weight, such as greater than 10% to 20% by weight, such as greater than 10% to 15% by weight, such as greater than 15% to 70% by weight, such as greater than 15% to 50% by weight, such as 15% to 40% by weight, such as 15% to 30% by weight, such as 15% to 25% by weight, such as 20% to 70% by weight, such as 20% to 50% by weight, such as 20% to 40% by weight, such as 20% to 30% by weight, such as 20% to 25% by weight, based on the total weight of the composition.
Aspect 3. The fire-retardant powder coating of aspect 1, wherein the filler comprises calcium carbonate, wherein calcium carbonate is present in an amount of greater than 10% by weight when the composition comprises titanium dioxide in an amount of at least 5% by weight, based on the total weight of the composition; and/or calcium carbonate is present in an amount of greater than 5% to no more than 70% by weight, such as greater than 5% to 50% weight, such as greater than 5% to 40% by weight, such as greater than 5% to 30% by weight, such as greater than 5% to 25% by wight, such as greater than 5% to 20% by weight, such as greater than 5% to 15% by weight, such as 10% to 70% by weight, such as 10% to 50% by weight, such as 10% to 40% by weight, such as 10% to 30% by weight, such as 10% to 25% by weight, such as 10% to 20% by weight, such as 10% to 15% by weight, such as greater than 10% to 70% by weight, such as greater than 10% to 50% by weight, such as greater than 10% to 40% by weight, such as greater than 10% to 30% by weight, such as greater than 10% to 25% by weight, such as greater than 10% to 20% by weight, such as greater than 10% to 15% by weight, such as greater than 15% to 70% by weight, such as greater than 15% to 50% by weight, such as 15% to 40% by weight, such as 15% to 30% by weight, such as 15% to 25% by weight, such as 20% to 70% by weight, such as 20% to 50% by weight, such as 20% to 40% by weight, such as 20% to 30% by weight, such as 20% to 25% by weight, based on the total weight of the composition.
Aspect 4. The fire-retardant powder coating of aspect 1, wherein the filler comprises aluminum hydroxide, wherein aluminum hydroxide is present in an amount of greater than 10% by weight when the composition comprises titanium dioxide in an amount of at least 5% by weight, based on the total weight of the composition; and wherein the composition comprises less than 5% by weight of an organo silane.
Aspect 5. The fire-retardant powder coating of aspect 4, wherein aluminum hydroxide is present in an amount of greater than 5% to no more than 70% by weight, such as greater than 5% to 50% weight, such as greater than 5% to 40% by weight, such as greater than 5% to 30% by weight, such as greater than 5% to 25% by wight, such as greater than 5% to 20% by weight, such as greater than 5% to 15% by weight, such as 10% to 70% by weight, such as 10% to 50% by weight, such as 10% to 40% by weight, such as 10% to 30% by weight, such as 10% to 25% by weight, such as 10% to 20% by weight, such as 10% to 15% by weight, such as greater than 10% to 70% by weight, such as greater than 10% to 50% by weight, such as greater than 10% to 40% by weight, such as greater than 10% to 30% by weight, such as greater than 10% to 25% by weight, such as greater than 10% to 20% by weight, such as greater than 10% to 15% by weight, such as greater than 15% to 70% by weight, such as greater than 15% to 50% by weight, such as 15% to 40% by weight, such as 15% to 30% by weight, such as 15% to 25% by weight, such as 20% to 70% by weight, such as 20% to 50% by weight, such as 20% to 40% by weight, such as 20% to 30% by weight, such as 20% to 25% by weight, based on the total weight of the composition.
Aspect 6. The fire-retardant powder coating composition of any of the preceding aspects, wherein the film-forming component comprises a thermosetting or thermoplastic binder present in an amount of greater than 40% by weight, based on the total weight of the composition.
Aspect 7. The fire-retardant powder coating composition of any of the preceding aspects, wherein the thermosetting binder comprises a film-forming resin and a curing agent.
Aspect 8. The fire-retardant powder coating composition of aspect 7, wherein the film-forming resin comprises (meth)acrylate resin, polyurethane, polyester, polyamide, polyether, polysiloxane, epoxy resin, vinyl resin, copolymer thereof, and combination thereof; and the curing agent comprises phenolic resin, amino resin, epoxy resin, triglycidyl isocyanurate, guanadine, dicyandiamide, tertiary amine, imidazole, mercaptan, aromatic, alicyclic, and/or aliphatic anhydride, beta-hydroxy (alkyl) amide, alkylated carbamate, (meth)acrylate, salts of poly carboxylic acids with cyclic amidine, o-tolyl biguanide, polyisocyanate, blocked polyisocyanate, polyacid, anhydride, organometallic acid-functional material, polyamine, polyamide, aminoplasts, carbodiimides, oxazolines, and/or derivatives and combinations thereof.
Aspect 9. The fire-retardant powder coating composition of aspects 7 or 8, wherein the film-forming component comprises an epoxy resin and the curing agent comprises dicyandiamide.
Aspect 10. The fire-retardant powder coating composition of aspects 7 to 9, wherein film-forming resin is present in the binder in an amount of 10% to 99.9% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder; and the curing agent is present in an amount of 0.1% to 70% by weight, such as 0.1% to 50% by weight, such as 0.1% to 35% by weight, such as 0.1% to 20% by weight, such as 1% to 70% by weight, such as 1% to 50% by weight, such as 1% to 35% by weight, such as 1% to 20% by weight, such as 3% to 70% by weight, such as 3% to 50% by weight, such as 3% to 35% by weight, such as 3% to 20% by weight, such as 10% to 70% by weight, such as 10% to 50% by weight, such as 10% to 35% by weight, such as 10% to 20% by weight, based on the total weight of the binder.
Aspect 11. The fire-retardant powder coating composition of any of the preceding aspects, wherein the film-forming component is present in an amount of 40% to 79.9% by weight, such as 40% to 70% by weight, such as 40% to 60% by weight, such as 45% to 79.9% by weight, such as 45% to 70% by weight, such as 45% to 60% by weight, such as 50% to 79.9% by weight, such as 50% to 70% by weight, such as 50% to 60% by weight, such as 55% to 79.9% by weight, such as 55% to 70% by weight, such as 55% to 60% by weight, such as 60% to 79.9% by weight, such as 60% to 70% by weight, such as 70% to 79.9% by weight, based on the total weight of the composition.
Aspect 12. The fire-retardant powder coating composition of any of the preceding aspects, wherein the film-forming component comprises a thermosetting binder present in an amount of greater than 40% by weight to no more than 79.9% by weight, such as greater than 40% by weight to no more than 70% by weight, such as greater than 40% by weight to no more than 60% by weight, such as 45% to 79.9% by weight, such as 45% to 70% by weight, such as 45% to 60% by weight, such as 50% to 79.9% by weight, such as 50% to 70% by weight, such as 50% to 60% by weight, such as 55% to 79.9% by weight, such as 55% to 70% by weight, such as 55% to 60% by weight, such as 60% to 79.9% by weight, such as 60% to 70% by weight, such as 70% to 79.9% by weight, based on the total weight of the composition.
Aspect 13. The fire-retardant powder coating composition of any of the preceding aspects, wherein the phosphate source comprises ammonium polyphosphate.
Aspect 14. The fire-retardant powder coating composition of any of the preceding aspects, wherein the phosphate source is present in an amount of 15% to 50% by weight, such as 15% to 45% by weight, such as 15% to 40% by weight, such as 15% to 35% by weight, such as 15% to 30% by weight, such as 15% to 25% by weight, such as 18% to 50% by weight, such as 18% to 45% by weight, such as 18% to 40% by weight, such as 18% to 35% by weight, such as 18% to 30% by weight, such as 18% to 25% by weight, such as 20% to 50% by weight, such as 20% to 45% by weight, such as 20% to 40% by weight, such as 20% to 35% by weight, such as 20% to 30% by weight, such as 20% to 25% by weight, such as 25% to 50% by weight, such as 25% to 45% by weight, such as 25% to 40% by weight, such as 25% to 35% by weight, such as 25% to 30% by weight, such as 25% to 25% by weight based on the total weight of the composition.
Aspect 15. The fire-retardant powder coating composition of any of the preceding aspects, wherein the clay comprises kaolin clay and the silica comprises corpuscular Neuberg silica in a weight ratio of clay to silica from 1:99 to 99:1, such as 1:9 to 9:1, such as 1:7 to 7:1, such as 1:5 to 5:1, such as 1:3 to 3:1, such as 1:2 to 2:1.
Aspect 16. A substrate coated with the fire-retardant powder coating composition of any of the preceding aspects.
Aspect 17. The substrate of aspect 16, wherein the substrate comprises an energy storage device, such as a fuel cell, hydrogen tank, or a battery and/or a battery component, such as an electric vehicle battery or battery component.
Aspect 18. The substrate of aspect 17, wherein the battery component comprises an electrode, a battery cell, a battery shell, a battery module, a battery pack, a battery box, a battery cell casing, a pack shell, a battery lid and/or tray, a thermal management system, an inverter, a battery housing, a module housing, a module racking, a battery side plate, a battery cell enclosure, a cooling module, a cooling tube, a cooling fin, a cooling plate, a cold plate assembly, a bus bar, a battery frame, an electrical connection, metal wires, copper or aluminum conductors or cables, or any part of a stationary electrical energy storage system.
Aspect 19. The substrate of any of the preceding aspects 16 to 18, wherein the powder coating on the substrate passes the Thermal Runaway Test.
Aspect 20. The substrate of any of the preceding aspects 16 to 19, wherein the substrate further comprises an additional coating layer such as a layer between the substrate and the powder coating.
Aspect 21. The substrate of aspect 20, wherein the additional coating layer comprises an electrodeposited coating layer deposited from an electrodepositable coating composition comprising an electrodepositable binder comprising an active hydrogen-containing, ionic salt group-containing film-forming polymer, and a curing agent.
Aspect 22. The substrate of aspect 21, wherein the electrodeposited coating layer further comprises a plate-like pigment present in a plate-like pigment-to-binder ratio of at least 0.4:1, such as at least 0.5:1, such as at least 0.6:1, such as at least 0.75:1, such as at least 1:1, such as at least 1.25:1, such as at least 1.5:1, and/or the electrodeposited coating layer further comprises a plate-like pigment present in a plate-like pigment-to-binder ratio of 0.4:1 to 2:1, such as 0.4:1 to 1.75:1, such as 0.4:1 to 1.5:1, such as 0.4:1 to 1.25:1, such as 0.4:1 to 1:1, such as 0.4:1 to 0.75:1, such as 0.4:1 to 0.7:1, such as 0.4:1 to 0.6:1, such as 0.4:1 to 0.55:1, such as 0.4:1 to 0.5:1, such as 0.5:1 to 2:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.7:1, such as 0.5:1 to 0.6:1, such as 0.5:1 to 0.55:1, such as 0.6:1 to 2:1, such as 0.6:1 to 1.75:1, such as 0.6:1 to 1.5:1, such as 0.6:1 to 1.25:1, such as 0.6:1 to 1:1, such as 0.6:1 to 0.75:1, such as 0.6:1 to 0.7:1, such as 0.75:1 to 2:1, such as 0.75:1 to 1.75:1, such as 0.75:1 to 1.5:1, such as 0.75:1 to 1.25:1, such as 0.75:1 to 1:1, such as 1:1 to 2:1, such as 1:1 to 1.75:1, such as 1:1 to 1.5:1, such as 1:1 to 1.25:1, such as 1.25:1 to 2:1, such as 1.25:1 to 1.75:1, such as 1.25:1 to 1.5:1, such as 1.5:1 to 2:1, such as 1.5:1 to 1.75:1.
Aspect 23. The substrate of aspect 22, wherein the plate-like pigment has an average equivalent spherical diameter of at least 50 nm, or at least 0.2 microns, or at least 0.4 microns, or at least 0.6 microns, or at least 1 micron, or at least 2 microns, or at least 3 microns, or at least 4 microns, or at least 5 microns and/or no more than 25 microns, or no more than 15 microns, or no more than 10 microns, or no more than 5 microns, or no more than 3.5 microns, or no more than 2.5 microns, or no more than 1.9 microns, or no more than 1.5 microns, or no more than 1 microns.
Aspect 24. The substrate of aspect 22 or 23, wherein the plate-like pigment comprises a phyllosilicate pigment.
Aspect 25. The substrate of aspect 24, wherein the phyllosilicate pigment comprises mica, chlorite, serpentine, talc, a clay material such as kaolin clay, or a combination thereof.
Aspect 26. A method of coating a substrate comprising optionally electrodepositing a coating from an electrodepositable coating composition to at least a portion of a surface of the substrate to form an electrodeposited coating layer; and applying the fire-retardant powder coating composition of any of aspects 1 to 15 over at least a portion of the surface of the substrate or the electrodeposited coating layer, if present, by electrostatic spraying or fluidized bed application to form a fire-retardant powder coating layer.
Aspect 27. The method of aspect 26, wherein the electrodeposited coating layer is present and the electrodepositable coating composition comprises plate-like pigment in a plate-like pigment-to-binder ratio of at least 0.4:1, such as at least 0.5:1, such as at least 0.6:1, such as at least 0.75:1, such as at least 1:1, such as at least 1.25:1, such as at least 1.5:1, and/or the electrodepositable coating composition comprises plate-like pigment in a plate-like pigment-to-binder ratio of 0.4:1 to 2:1, such as 0.4:1 to 1.75:1, such as 0.4:1 to 1.5:1, such as 0.4:1 to 1.25:1, such as 0.4:1 to 1:1, such as 0.4:1 to 0.75:1, such as 0.4:1 to 0.7:1, such as 0.4:1 to 0.6:1, such as 0.4:1 to 0.55:1, such as 0.4:1 to 0.5:1, such as 0.5:1 to 2:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.7:1, such as 0.5:1 to 0.6:1, such as 0.5:1 to 0.55:1, such as 0.6:1 to 2:1, such as 0.6:1 to 1.75:1, such as 0.6:1 to 1.5:1, such as 0.6:1 to 1.25:1, such as 0.6:1 to 1:1, such as 0.6:1 to 0.75:1, such as 0.6:1 to 0.7:1, such as 0.75:1 to 2:1, such as 0.75:1 to 1.75:1, such as 0.75:1 to 1.5:1, such as 0.75:1 to 1.25:1, such as 0.75:1 to 1:1, such as 1:1 to 2:1, such as 1:1 to 1.75:1, such as 1:1 to 1.5:1, such as 1:1 to 1.25:1, such as 1.25:1 to 2:1, such as 1.25:1 to 1.75:1, such as 1.25:1 to 1.5:1, such as 1.5:1 to 2:1, such as 1.5:1 to 1.75:1.
Aspect 28. The method of aspect 26 or 27, wherein the substrate coated by the method comprises any of the substrates of aspects 16 to 25.

Illustrating the disclosure are the following examples, which, however, are not to be considered as limiting the disclosure to their details. Unless otherwise indicated, all parts and percentages in the following examples, as well as throughout the specification, are by weight.

### Examples

The following examples are intended to illustrate the disclosure and should not be construed as limiting the disclosure in any way.

Powder coating compositions, POWDERS 1 and 2, were prepared from the components listed in Table 1 in parts by weight according to the procedure described below:

TABLE 1
POWDERS 1 and 2

| | POWDER 1 | POWDER 2 |
|---|---|---|
| Coating film-forming component | 100 | 66.6 |
| comprising an epoxy resin and | | |
| curing agent | | |
| Ammonium Polyphosphate | — | 20 |
| Filler (blend of silica and clay) | — | 13.4 |

For POWDERS 1 and 2, each of the components listed in Table 1 were weighed in a container and mixed to form a dry homogeneous mixture. The mixture was then melt-mixed in an extruder. The extruded material was dropped onto chill rolls to cool and re-solidify the mixtures into solid chips. The chips were milled to a fine powder. The resulting coating compositions for each of POWDERS 1 and 2 were solid particulate powder coating compositions.

POWDERS 1 and 2 were applied with a powder coating gun to battery lids that were precoated with an electrodeposited coating layer. The powder coatings were baked for a sufficient time and at a sufficient temperature to effectuate cure. The coated materials were tested using the Thermal Runaway Test simulation as described herein. POWDER 1 did not pass. POWDER 2 passed the Thermal Runaway Test.

Coated substrates comprising the electrocoated substrate only, as well as POWDERS 1 or 2 applied over the electrocoated substrate, were tested for corrosion resistance. The substrates comprising POWDERS 1 and 2 on electrocoated substrate all showed improved corrosion resistance compared to a substrate having only the electrocoat without a powder coating layer. The corrosion resistance may be tested according to ASTM B-117 or SAE J2334.

Whereas particular examples of this disclosure have been described above for purposes of illustration, it will be evident to those skilled in the art that numerous variations of the details of the present disclosure may be made without departing from the disclosure as defined in the appended claims.

1. A fire-retardant powder coating composition comprising:
a) a film-forming component;
b) a phosphate source; and
c) a filler material comprising clay and optionally silica, wherein the clay and optional silica combined is present in an amount of greater than 5% by weight, based on the total weight of the composition.

2. The fire-retardant powder coating composition of claim 1, wherein the film-forming component comprises a thermosetting or thermoplastic binder present in an amount of greater than 40% by weight, based on the total weight of the composition.

3. The fire-retardant powder coating composition of claim 2, wherein the thermosetting binder comprises a film-forming resin comprising an epoxy resin and a curing agent comprising dicyandiamide.

4. The fire-retardant powder coating composition of claim 1, wherein the film-forming component comprises an epoxy resin.

5. The fire-retardant powder coating composition of claim 1, wherein the phosphate source comprises ammonium polyphosphate.

6. The fire-retardant powder coating composition of claim 1, wherein the phosphate source is present in an amount of 15 to 50% by weight, based on the total weight of the composition.

7. The fire-retardant powder coating composition of claim 1, wherein the clay comprises kaolin clay and the optional silica comprises corpuscular silica in a weight ratio of clay to silica from 1:3 to 3:1.

8. A fire-retardant powder coating composition comprising:
a) a film-forming component;
b) a phosphate source; and
c) a filler material comprising calcium carbonate, wherein calcium carbonate is present in an amount of greater than 10% by weight when the composition comprises titanium dioxide in an amount of at least 5% by weight, based on the total weight of the composition.

9. A fire-retardant powder coating composition comprising:
a) a film-forming component;
b) a phosphate source; and
c) a filler material comprising aluminum hydroxide,
wherein aluminum hydroxide is present in an amount of greater than 10% by weight when the composition comprises titanium dioxide in an amount of at least 5% by weight, based on the total weight of the composition; and
wherein the composition comprises less than 5% by weight of an organo silane.

10. A substrate coated with the fire-retardant powder coating composition of claim 1.

11. The substrate of claim 10, wherein the substrate comprises a battery and/or a battery component.

12. The substrate of claim 11, wherein the battery component comprises an electrode, a battery cell, a battery shell, a battery module, a battery pack, a battery box, a battery cell casing, a pack shell, a battery lid and/or tray, a thermal management system, an inverter, a battery housing, a module housing, a module racking, a battery side plate, a battery cell enclosure, a cooling module, a cooling tube, a cooling fin, a cooling plate, a cold plate assembly, a bus bar, a battery frame, an electrical connection, metal wires, copper or aluminum conductors or cables, or any part of a stationary electrical energy storage system.

13. The substrate of claim 10, wherein the powder coating passes the Thermal Runaway Test.

14. The substrate of claim 10, further comprising an additional coating layer between the substrate and the powder coating, such as an electrodeposited coating layer.

15. The substrate of claim 14, wherein the electrodeposited coating layer further comprises a plate-like pigment present in a plate-like pigment-to-binder ratio of at least 0.4:1.

16. The substrate of claim 15, wherein the plate-like pigment has an average equivalent spherical diameter of at least 0.2 microns and no more than 5 microns.

17. The substrate of claim 15, wherein the plate-like pigment comprises a phyllosilicate pigment.

18. The substrate of claim 17, wherein the phyllosilicate pigment comprises mica, chlorite, serpentine, talc, kaolin clay, or a combination thereof.

19. A method of coating a substrate comprising:
optionally electrodepositing a coating from an electrodepositable coating composition to at least a portion of a surface of the substrate to form an electrodeposited coating layer; and
applying the fire-retardant powder coating composition of claim 1 over at least a portion of the surface of the substrate or the electrodeposited coating layer, if present, by electrostatic spraying or fluidized bed application to form a fire-retardant powder coating layer.

20. The method of claim 19, wherein the electrodeposited coating layer is present and the electrodepositable coating composition comprises plate-like pigment in a plate-like pigment-to-binder ratio of at least 0.4:1.
